(19) United States
(12) Patent Application Publication
(10) Pub. No.: US 2017/0055300 A1
(43) Pub. Date: Feb. 23, 2017

(54) BLOCK ACKNOWLEDGMENT MECHANISM

(71) Applicant: QUALCOMM Incorporated, San Diego, CA (US)

(72) Inventor: Vijayaraja Pitchaiah, Thanjavur (IN)

(21) Appl. No.: 14/831,667

(22) Filed: Aug. 20, 2015

(51) Int. Cl. H04W 76/02

(52) U.S. Cl. CPC H04W 76/021

(57) ABSTRACT

Methods and apparatuses are disclosed that may reduce overhead associated with setting up and tearing down block acknowledgment (BA) sessions between wireless devices. For one embodiment, wireless devices may establish one or more BA sessions with each other during an association procedure, for example, by providing BA session requests and related information within an association request frame. For another embodiment, two or more BA sessions may be established using a single exchange of ADDBA request and ADDBA response frames, for example, by including traffic identifier (TID) values for the two or more BA sessions in the ADDBA request frame. Similarly, two or more BA sessions may be torn down using a single DELBA request frame, for example, by including TID values for the two or more BA sessions in the DELBA request frame.

### TECHNICAL FIELD

The example embodiments relate generally to wireless networks, and specifically to block acknowledgment sessions in wireless networks.

### BACKGROUND OF RELATED ART

A wireless local area network (WLAN) may be formed by one or more access points (APs) that provide a shared wireless communication medium for use by a number of client devices or stations (STAs). Each AP, which may correspond to a Basic Service Set (BSS), periodically broadcasts beacon frames to enable any STAs within wireless range of the AP to establish and/or maintain a communication link with the WLAN. Once a STA is associated with the AP, the AP and the STA may exchange data frames. When the STA receives a data frame from the AP, the STA is to transmit an acknowledgment (ACK) frame back to the AP to acknowledge receipt of the data frame.

A block acknowledgement (BA) session may allow the STA to acknowledge receipt of multiple data frames using a single ACK frame. More specifically, the STA may use a block acknowledgment frame (BA frame) to acknowledge receipt of a plurality of data frames and/or a number of aggregated data frames (e.g., rather than confirming receipt of each data frame with a corresponding ACK frame). In this manner, the BA session may reduce the number of ACK frames transmitted to the AP, which in turn may reduce congestion of the wireless medium.

The BA session may be established between the STA and the AP by exchanging add block acknowledgement (ADDBA) request and response frames. The ADDBA request frame may include information about the requested BA session, and the ADDBA response frame may indicate acceptance or denial of the requested BA session. At present, separate BA sessions are established for different classes or priorities of traffic. For example, a first BA session may be established for voice traffic, a second BA session may be established for video traffic, a third BA session may be established for “best-effort” traffic, and so on.

Because each BA session may be associated with an exchange of ADDBA request and response frames, establishing one or more BA sessions between wireless devices may consume limited bandwidth of a shared wireless medium. Accordingly, it would be desirable to establish one or more BA sessions between wireless devices using as few frame exchanges as possible.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Methods and apparatuses are disclosed that may allow wireless devices to setup and/or tear down a number of block acknowledgement (BA) sessions using fewer frame exchanges than conventional techniques. For some embodiments, one or more BA sessions may be established between wireless devices without exchanging any ADDBA request or ADDBA response frames, for example, by negotiating and establishing the one or more BA sessions during an association procedure. More specifically, for at least some example embodiments, a number of BA sessions may be established between a first wireless device and a second wireless device by: receiving an association request frame from the second wireless device, the association request frame including a first request to associate with the first wireless device and including a second request to establish one or more BA sessions with the first wireless device; transmitting an association response frame to the second wireless device, the association response frame including information indicating whether the second request is accepted by the first wireless device; associating the second wireless device with the first wireless device based, at least in part, on the association request frame and the association response frame; and establishing the one or more BA sessions between the first wireless device and the second wireless device based, at least in part, on the association request frame and the association response frame. In this manner, the one or more BA sessions may be established during association of the second wireless device with the first wireless device.

For some embodiments, the association request frame includes a block acknowledgment information element (IE) containing the second request to establish the one or more BA sessions. The block acknowledgment IE may further comprise at least one member of the group consisting of a BA policy, one or more BA buffer sizes, one or more BA session timeout values, one or more aggregation policies, and one or more traffic identifier (TID) values. The block acknowledgment IE may indicate a BA keep-alive interval for each of the one or more BA sessions. The block acknowledgment IE may indicate whether the second wireless device supports aggregation of data having different traffic identifier (TID) values in a single BA session. The block acknowledgment IE may specify a default number of BA sessions to be established during association of the second wireless device with the first wireless device. The block acknowledgment IE may include a separate BA parameter control set for each of a number of different TID values. The block acknowledgment IE may indicate a timeout period for a number of specified BA sessions, and the number of specified BA sessions may be torn down the after expiration of the timeout period without frame exchanges between the first and second wireless devices.

### BRIEF DESCRIPTION OF THE DRAWINGS

The example embodiments are illustrated by way of example and are not intended to be limited by the figures of the accompanying drawings, where like reference numerals refer to corresponding parts throughout the drawing figures.

FIG. 1 shows a block diagram of a wireless system within which the example embodiments may be implemented.

FIG. 2 shows a block diagram of a wireless station (STA) in accordance with example embodiments.

FIG. 3 shows a block diagram of an access point (AP) in accordance with example embodiments.

FIG. 4A shows an example add block acknowledgment (ADDBA) request frame in accordance with some embodiments.

FIG. 4B shows an example ADDBA response frame in accordance with some embodiments.

FIG. 4C shows an example delete block acknowledgment (DELBA) frame in accordance with some embodiments.

FIG. 5 is a sequence diagram depicting an example operation for establishing a connection between a STA and an AP and an example operation for initiating and tearing down two block acknowledgement sessions between the STA and the AP.

FIG. 6A shows an example association request frame in accordance with some embodiments.

FIG. 6B shows an example association response frame in accordance with some embodiments.

FIG. 7 shows an example block acknowledgment multi-session Information Element (IE) in accordance with some embodiments.

FIG. 8A is a sequence diagram depicting an example operation for establishing one or more block acknowledgement sessions during an association procedure, in accordance with example embodiments.

FIG. 8B is a sequence diagram depicting another example operation for establishing one or more block acknowledgement sessions during an association procedure, in accordance with example embodiments.

FIG. 9 shows an example traffic identifier (TID) Map IE in accordance with some embodiments.

FIG. 10 is a sequence diagram depicting an example operation for establishing and tearing down two or more block acknowledgement sessions, in accordance with some embodiments.

FIG. 11 is an illustrative flow chart depicting an example operation for establishing one or more block acknowledgement sessions during an association procedure, in accordance with some embodiments.

FIG. 12 is an illustrative flow chart depicting an example operation for establishing two or more block acknowledgement sessions, in accordance with some embodiments.

FIG. 13 is an illustrative flow chart depicting an example operation for tearing down two or more block acknowledgment sessions, in accordance with some embodiments.

### DETAILED DESCRIPTION

The example embodiments are described below in the context of data exchanges between Wi-Fi enabled devices for simplicity only. It is to be understood that the example embodiments are equally applicable to data exchanges using signals of other various wireless standards or protocols. As used herein, the terms “WLAN” and “Wi-Fi” can include communications governed by the IEEE 802.11 family of standards, Bluetooth, HiperLAN (a set of wireless standards, comparable to the IEEE 802.11 Standards, used primarily in Europe), and other technologies having relatively short radio propagation range. In addition, although described herein in terms of exchanging data frames between wireless devices, the example embodiments may be applied to the exchange of any data unit, packet, and/or frame between wireless devices. Thus, the term “data frame” may include any frame, packet, or data unit such as, for example, protocol data units (PDUs), Media Access Control (MAC) protocol data units (MPDUs), and physical layer convergence procedure protocol data units (PPDUs). The term “A-MPDU” may refer to aggregated MPDUs.

Further, the term “Traffic Identifier (TID)” refers to a traffic classification indicating the relative priority level of traffic or data, and the term “access category” refers to data that may be queued together or aggregated according to priority level. More specifically, the TID indicates the priority level of the data, and may thus be mapped to a corresponding access category (AC). Thus, as used herein, the terms “TID,” “access category,” and “priority level” may be used interchangeably. However, it is to be understood that, for at least some embodiments, there may not be a one-to-one correspondence between TID values and access categories. By classifying data according to its TID, a transmitting device may aggregate data of the same priority level in a common set of AC queues. The aggregated data may be transmitted over a shared wireless medium as aggregated data frames such as, for example, A-MPDUs and/or aggregate MAC service data units (A-MSDUs).

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. The example embodiments are not to be construed as limited to specific examples described herein but rather to include within their scopes all embodiments defined by the appended claims.

As mentioned above, current Wi-Fi standards allow wireless devices (e.g., STAs and/or APs) to acknowledge multiple data frames or aggregated data frames using a single block acknowledgement (BA) frame. More specifically, the IEEE 802.11 standards may improve efficiency of the wireless medium by allowing a receiving device to confirm receipt of a plurality of frames from a transmitting device using a single BA frame. As a result, the transmitting device may continuously transmit a plurality of data frames (rather than waiting for an ACK frame every time one data frame is transmitted to the receiving device). In addition, the IEEE 802.11 standards support frame aggregation, which allows the transmitting device to aggregate a plurality of MAC frames into an A-MPDU frame and then transmit the A-MPDU frame at higher transmission rates. The receiving device may use a BA frame to confirm receipt of the aggregated frames transmitted within the A-MPDU frame.

Before a pair of wireless devices may use BA frames to confirm receipt of each other's data transmissions, the wireless devices first enter a BA setup phase during which capability information (e.g., buffer size and block acknowledgement policies) are negotiated with each other. This setup phase may involve the exchange of an add block acknowledgment (ADDBA) request frame and an ADDBA response frame. Once the setup phase is completed, the wireless devices may then send multiple data frames to each other without waiting for individual ACK frames; instead, the receiving device may acknowledge receipt of a plurality of data frames using a single BA frame. The block acknowledgement agreement may be torn down (e.g., terminated) by sending a Delete Block Acknowledgment (DELBA) frame to the other wireless device. These block acknowledgment agreements may be called BA sessions.

As mentioned above, a separate BA session is typically established for each different access category or traffic priority level. Assigning data to different access categories or priorities may ensure that higher priority data (e.g., voice data) is allocated higher transmission priorities than lower priority data (e.g., emails). For example, in many WLAN systems, data may be assigned to one of at least four access categories (ACs): the highest priority data (e.g., voice data) may be assigned to a first access category (AC_VO); the second highest priority data (e.g., video data) may be assigned to a second access category (AC_VI); the third highest priority data (e.g., data associated with a “best effort” QoS) may be assigned to a third access category (AC_BE); and the lowest priority data (e.g., background data) may be assigned to a fourth access category (AC_BK). For actual embodiments, data may be assigned to any number of different access categories, and therefore the four access categories discussed above are merely illustrative.

A wireless network in which data is assigned to a number N of different access categories typically establishes a separate BA session for each of the N different access categories. Establishing a separate BA session for each of a number N of access categories may therefore involve N different exchanges of ADDBA request and ADDBA response frames. Similarly, because tearing down a BA session typically involves an exchange of a DELBA frame and an acknowledgement (ACK) frame, tearing down a number N of separate BA sessions may involve N different exchanges of DELBA and ACK frames. Because each BA session may take a significant amount of time to set up and tear down, it would be advantageous to set up and/or tear down a number N of BA sessions using fewer frame exchanges, for example, to reduce traffic on the shared wireless medium.

Thus, as explained in more detail below, the example embodiments may allow wireless devices to setup and/or tear down a number of BA sessions using fewer frame exchanges than conventional techniques. For some embodiments, one or more BA sessions may be established between wireless devices without exchanging any ADDBA request or ADDBA response frames, for example, by negotiating and establishing the one or more BA sessions during an association procedure (e.g., when a STA associates with an AP). More specifically, to set up a number of BA sessions during an association procedure, the transmitting device (e.g., a STA) may insert or embed a BA information element (IE) into an association request frame, and transmit the association request frame to the receiving device (e.g., the AP). The BA information element may include information necessary to establish the one or more BA sessions between the transmitting device and the receiving device. For at least one embodiment, the BA information element may include BA policies, buffer sizes, BA session timeout values, aggregation policies, TID values, and so on.

For another embodiment, a plurality of different BA sessions (e.g., for a corresponding plurality of different access categories) may be established between wireless devices using a single exchange of an ADDBA request frame and an ADDBA response frame. More specifically, to set up a plurality of different BA sessions using a single pair of ADDBA request and ADDBA response frames, the requesting device (e.g., an AP) may insert or embed the BA information element (described above) within an ADDBA request frame, and transmit the ADDBA request frame to the responding device (e.g., a STA). For at least one embodiment, the BA information element may include BA policies, buffer sizes, BA session timeout values, aggregation policies, TID values, and so on.

Thus, as described in more detail below, the example embodiments may not only reduce traffic overhead associated with establishing BA sessions but may also reduce the setup time to establish multiple BA sessions (e.g., corresponding to different access categories or traffic priorities) between the wireless devices.

The example embodiments may also allow multiple BA sessions to be torn down using a single DELBA frame. More specifically, a BA information element may be inserted or embedded within the DELBA frame. The BA information element may include information indicating which BA sessions should be torn down. These and other details of the example embodiments, which provide one or more technical solutions to the aforementioned technical problems, are described in more detail below.

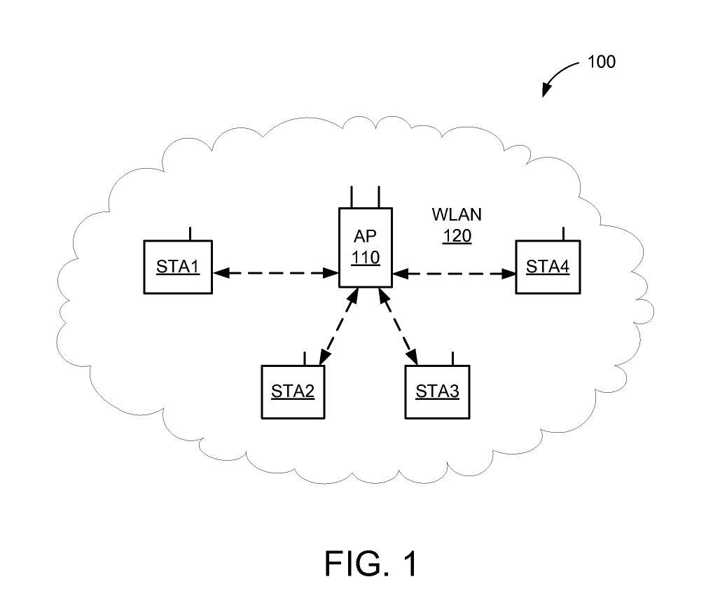

FIG. 1 is a block diagram of a wireless system 100 within which the example embodiments may be implemented. The wireless system 100 is shown to include four wireless stations STA1-STA4, a wireless access point (AP) 110, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that WLAN 120 may be formed by any number of access points such as AP 110. The AP 110 is assigned a unique MAC address that is programmed therein by, for example, the manufacturer of the access point. Similarly, each of STA1-STA4 is also assigned a unique MAC address. For some embodiments, the wireless system 100 may correspond to a multiple-input multiple-output (MIMO) wireless network. Further, although the WLAN 120 is depicted in FIG. 1 as a BSS, for other example embodiments, WLAN 120 may be an infrastructure BSS (IBSS), an ad-hoc network, or a peer-to-peer (P2P) network (e.g., operating according to the Wi-Fi Direct protocols).

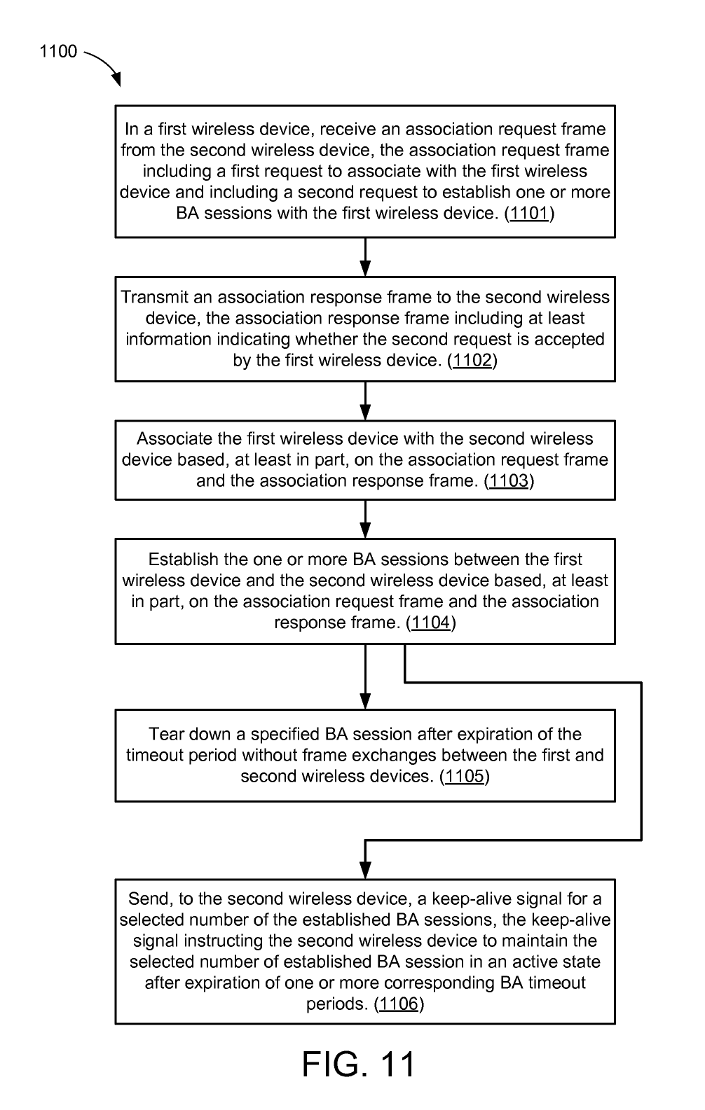

Each of stations STA1-STA4 may be any suitable Wi-Fi enabled wireless device including, for example, a cell phone, personal digital assistant (PDA), tablet device, laptop computer, or the like. Each station STA may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, each station STA may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 11-13.

The AP 110 may be any suitable device that allows one or more wireless devices to connect to a network (e.g., a local area network (LAN), wide area network (WAN), metropolitan area network (MAN), and/or the Internet) via AP 110 using Wi-Fi, Bluetooth, or any other suitable wireless communication standards. For at least one embodiment, AP 110 may include one or more transceivers, one or more processing resources (e.g., processors and/or ASICs), one or more memory resources, and a power source. The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 11-13.

For the stations STA1-STA4 and/or AP 110, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 900 MHz frequency band, a 2.4 GHz frequency band, a 5 GHz frequency band, and/or within a 60 GHz frequency band in accordance with the IEEE 802.11 family of standards. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within the STA may be any technically feasible transceiver such as a ZigBee transceiver described by a specification from the ZigBee specification, a WiGig transceiver, and/or a HomePlug transceiver described a specification from the HomePlug Alliance.

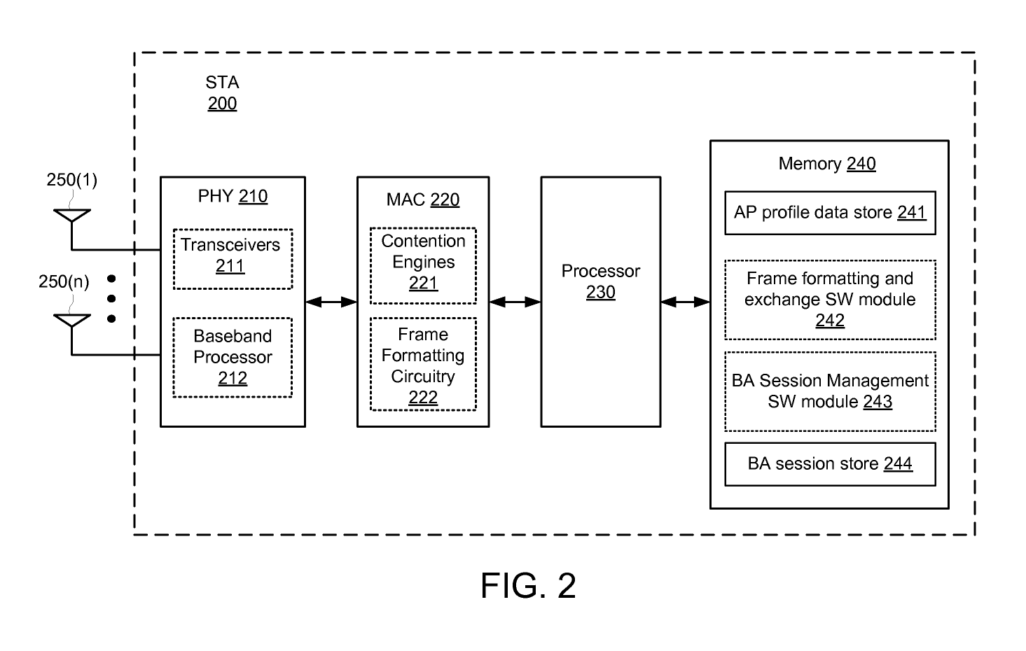

FIG. 2 shows an example STA 200 that may be one embodiment of one or more of the stations STA1-STA4 of FIG. 1. The STA 200 may include a physical layer (PHY) device 210 including at least a number of transceivers 211 and a baseband processor 212, may include a MAC 220 including at least a number of contention engines 221 and frame formatting circuitry 222, may include a processor 230, may include a memory 240, and may include a number of antennas 250(1)-250(n). The transceivers 211 may be coupled to antennas 250(1)-250(n), either directly or through an antenna selection circuit (not shown for simplicity). The transceivers 211 may be used to transmit signals to and receive signals from AP 110 and/or other STAs (see also FIG. 1), and may be used to scan the surrounding environment to detect and identify nearby access points and/or other STAs (e.g., within wireless range of STA 200). Although not shown in FIG. 2 for simplicity, the transceivers 211 may include any number of transmit chains to process and transmit signals to other wireless devices via antennas 250(1)-250(n), and may include any number of receive chains to process signals received from antennas 250(1)-250(n). Thus, for example embodiments, the STA 200 may be configured for multiple-input, multiple-output (MIMO) operations. The MIMO operations may include single-user MIMO (SU-MIMO) operations and multi-user MIMO (MU-MIMO) operations.

The baseband processor 212 may be used to process signals received from processor 230 and/or memory 240 and to forward the processed signals to transceivers 211 for transmission via one or more of antennas 250(1)-250(n), and may be used to process signals received from one or more of antennas 250(1)-250(n) via transceivers 211 and to forward the processed signals to processor 230 and/or memory 240.

For purposes of discussion herein, MAC 220 is shown in FIG. 2 as being coupled between PHY device 210 and processor 230. For actual embodiments, PHY device 210, MAC 220, processor 230, and/or memory 240 may be connected together using one or more buses (not shown for simplicity).

The contention engines 221 may contend for access to one or more shared wireless mediums, and may also store packets for transmission over the one or more shared wireless mediums. The STA 200 may include one or more contention engines 221 for each of a plurality of different access categories. For other embodiments, the contention engines 221 may be separate from MAC 220. For still other embodiments, the contention engines 221 may be implemented as one or more software modules (e.g., stored in memory 240 or stored in memory provided within MAC 220) containing instructions that, when executed by processor 230, perform the functions of contention engines 221.

The frame formatting circuitry 222 may be used to create and/or format frames received from processor 230 and/or memory 240 (e.g., by adding MAC headers to PDUs provided by processor 230), and may be used to re-format frames received from PHY device 210 (e.g., by stripping MAC headers from frames received from PHY device 210).

Memory 240 may include an AP profile data store 241 that stores profile information for a plurality of APs. The profile information for a particular AP may include information including, for example, the AP's service set identification (SSID), MAC address, channel information, received signal strength indicator (RSSI) values, goodput values, channel state information (CSI), supported data rates, supported channel access protocols, connection history with the AP, a trustworthiness value of the AP (e.g., indicating a level of confidence about the AP's location, etc.), and/or any other suitable information pertaining to or describing the operation of the AP. Memory 240 may also include a BA session store 244 that stores BA session information (e.g., BA policies, BA timeout values, buffer sizes, aggregation policies, TID values, and so on) for a number of active BA sessions between STA 200 and other wireless devices. For at least some embodiments, the BA session store 244 may also store BA session information for a number of previous or inactive BA sessions between STA 200 and other wireless devices.

Memory 240 may also include a non-transitory computer-readable medium (e.g., one or more nonvolatile memory elements, such as EPROM, EEPROM, Flash memory, a hard drive, and so on) that may store at least the following software (SW) modules:
a frame formatting and exchange software module 242 to facilitate the creation and exchange of any suitable frames (e.g., data frames, action frames, and management frames) between STA 200 and other wireless devices (e.g., as described for one or more operations of FIGS. 11-13); and
a BA session management software module 243 to facilitate the establishment, operation, and/or teardown of block acknowledgment sessions used by STA 200 in communications with one or more other STAs or APs (e.g., as described for one or more operations of FIGS. 11-13).

Each software module includes instructions that, when executed by processor 230, cause STA 200 to perform the corresponding functions. The non-transitory computer-readable medium of memory 240 thus includes instructions for performing all or a portion of the STA-side operations depicted in FIGS. 11-13.

Processor 230, which is shown in the example of FIG. 2 as coupled to PHY device 210, to MAC 220, and to memory 240, may be any suitable one or more processors capable of executing scripts or instructions of one or more software programs stored in STA 200 (e.g., within memory 240). For example, processor 230 may execute the frame formatting and exchange software module 242 to facilitate the creation and exchange of any suitable frames (e.g., data frames, action frames, and management frames) between STA 200 and other wireless devices. The frame formatting and exchange software module 242 may be also be executed by processor 230 to create block acknowledgement IEs that may include BA session information (e.g., BA policies, BA timeout values, buffer sizes, aggregation policies, TID values, and so on) and/or to embed or otherwise insert the block acknowledgement IEs into association request frames, ADDBA request frames, ADDBA response frames, and/or DELBA frames to be transmitted to other wireless devices. Processor 230 may also execute the BA session management software module 243 to facilitate the establishment, operation, and teardown of block acknowledgment sessions used by STA 200 in communications with one or more other STAs or APs.

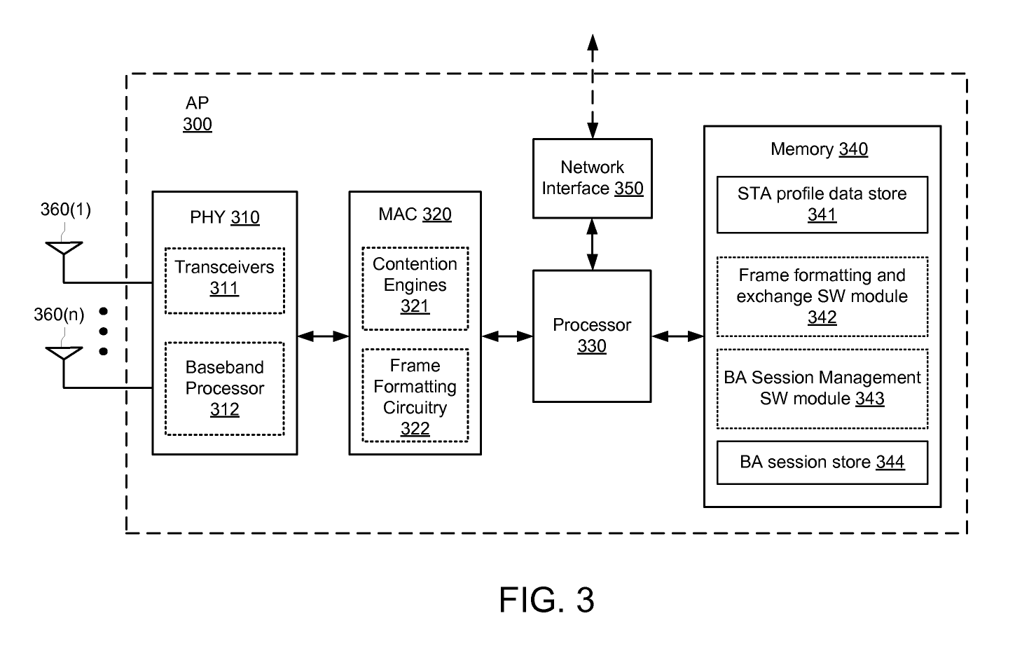

FIG. 3 shows an example AP 300 that may be one embodiment of the AP 110 of FIG. 1. AP 300 may include a PHY device 310 including at least a number of transceivers 311 and a baseband processor 312, may include a MAC 320 including at least a number of contention engines 321 and frame formatting circuitry 322, may include a processor 330, may include a memory 340, may include a network interface 350, and may include a number of antennas 360(1)-360(n). The transceivers 311 may be coupled to antennas 360(1)-360(n), either directly or through an antenna selection circuit (not shown for simplicity). The transceivers 311 may be used to communicate wirelessly with one or more STAs, with one or more other APs, and/or with other suitable devices. Although not shown in FIG. 3 for simplicity, the transceivers 311 may include any number of transmit chains to process and transmit signals to other wireless devices via antennas 360(1)-360(n), and may include any number of receive chains to process signals received from antennas 360(1)-360(n). Thus, for example embodiments, the AP 300 may be configured for MIMO operations including, for example, SU-MIMO operations and MU-MIMO operations.

The baseband processor 312 may be used to process signals received from processor 330 and/or memory 340 and to forward the processed signals to transceivers 311 for transmission via one or more of antennas 360(1)-360(n), and may be used to process signals received from one or more of antennas 360(1)-360(n) via transceivers 311 and to forward the processed signals to processor 330 and/or memory 340.

The network interface 350 may be used to communicate with a WLAN server (not shown for simplicity) either directly or via one or more intervening networks and to transmit signals.

Processor 330, which is coupled to PHY device 310, to MAC 320, to memory 340, and to network interface 350, may be any suitable one or more processors capable of executing scripts or instructions of one or more software programs stored in AP 300 (e.g., within memory 340). For purposes of discussion herein, MAC 320 is shown in FIG. 3 as being coupled between PHY device 310 and processor 330. For actual embodiments, PHY device 310, MAC 320, processor 330, memory 340, and/or network interface 350 may be connected together using one or more buses (not shown for simplicity).

The contention engines 321 may contend for access to the shared wireless medium, and may also store packets for transmission over the shared wireless medium. For some embodiments, AP 300 may include one or more contention engines 321 for each of a plurality of different access categories. For other embodiments, the contention engines 321 may be separate from MAC 320. For still other embodiments, the contention engines 321 may be implemented as one or more software modules (e.g., stored in memory 340 or within memory provided within MAC 320) containing instructions that, when executed by processor 330, perform the functions of contention engines 321.

The frame formatting circuitry 322 may be used to create and/or format frames received from processor 330 and/or memory 340 (e.g., by adding MAC headers to PDUs provided by processor 330), and may be used to re-format frames received from PHY device 310 (e.g., by stripping MAC headers from frames received from PHY device 310).

Memory 340 may include a STA profile data store 341 that stores profile information for a plurality of STAs. The profile information for a particular STA may include information including, for example, its MAC address, supported data rates, supported channel access protocols, connection history with the STA, and/or any other suitable information pertaining to or describing the operation of the STA. Memory 340 may also include a BA session store 344 that stores BA session information (e.g., BA policies, BA timeout values, buffer sizes, aggregation policies, TID values, and so on) for a number of active BA sessions between AP 300 and other wireless devices. For at least some embodiments, the BA session store 344 may also store BA session information for a number of previous or inactive BA sessions between AP 300 and other wireless.

Memory 340 may also include a non-transitory computer-readable medium (e.g., one or more nonvolatile memory elements, such as EPROM, EEPROM, Flash memory, a hard drive, and so on) that may store at least the following software (SW) modules:
a frame formatting and exchange software module 342 to facilitate the creation and exchange of any suitable frames (e.g., data frames, action frames, and management frames) between AP 300 and other wireless devices (e.g., as described for one or more operations of FIGS. 11-13); and
a BA session management software module 343 to facilitate the establishment, operation, and/or teardown of block acknowledgment sessions used by AP 300 in communications with one or more other STAs or APs (e.g., as described for one or more operations of FIGS. 11-13).

Each software module includes instructions that, when executed by processor 330, cause AP 300 to perform the corresponding functions. The non-transitory computer-readable medium of memory 340 thus includes instructions for performing all or a portion of the AP-side operations depicted in FIGS. 11-13.

Processor 330 may execute the frame formatting and exchange software module 342 to facilitate the creation and exchange of any suitable frames (e.g., data frames, action frames, and management frames) between AP 300 and other wireless devices. Processor 330 may also execute the frame formatting and exchange software module 342 to create block acknowledgement IEs that may include BA session information (e.g., BA policies, BA timeout values, buffer sizes, aggregation policies, TID values, and so on) and/or to embed or otherwise insert the block acknowledgement IEs into association response frames, ADDBA request frames, ADDBA response frames, and/or DELBA frames to be transmitted to other wireless devices. Processor 330 may also execute the BA session management software module 343 to facilitate the establishment, operation, and teardown of block acknowledgment sessions used by AP 300 in communications with one or more other STAs or APs.

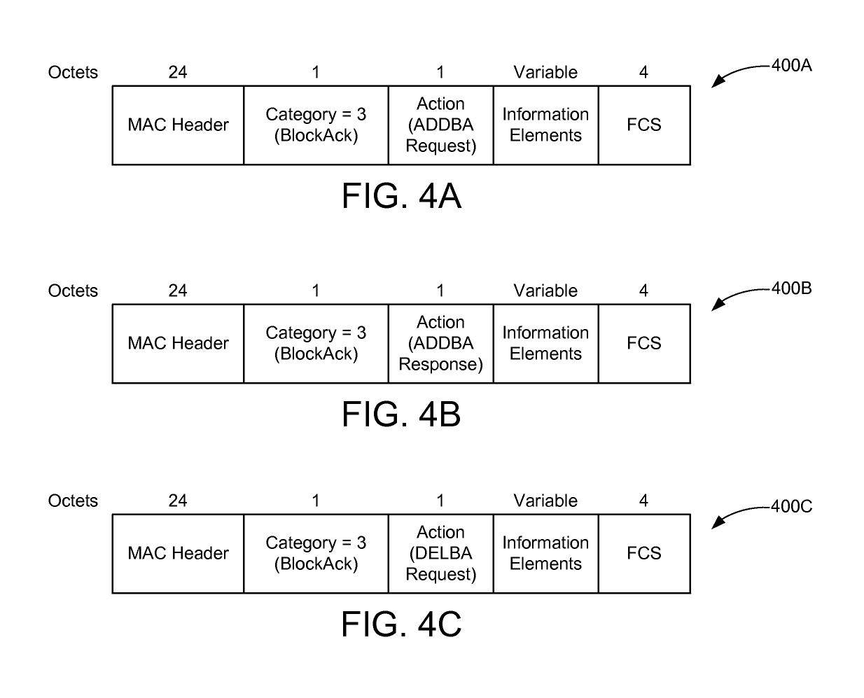

As mentioned above, the IEEE 802.11 standards allow wireless devices to acknowledge receipt of multiple data frames using a single BA frame. For example, referring again to FIG. 1, the AP 110 may initiate a BA session with STA1 by transmitting an add block acknowledgment (ADDBA) request frame to STA1. The ADDBA request frame is an action frame defined in the IEEE 802.11 standards. For example, FIG. 4A shows an example ADDBA request frame 400A including a MAC header, a category field, an action field, a number of information elements, and a frame control sequence (FCS) field. The number of octets denoted in FIG. 4A for the various fields of the ADDBA request frame 400A are illustrative, and may be of other suitable values. Upon receiving an ADDBA request frame, STA1 may transmit an ADDBA response frame back to the AP 110. The ADDBA response frame is an action frame defined in the IEEE 802.11 standards. For example, FIG. 4B shows an example ADDBA response frame 400B including a MAC header, a category field, an action field, a number of information elements, and an FCS field. The number of octets denoted in FIG. 4B for the various fields of the ADDBA response frame 400B are illustrative, and may be of other suitable values. STA1 may indicate acceptance of the ADDBA request frame 400A by setting a status code in the ADDBA response frame 400B to logic 0 (e.g., to indicate a “success” status in the ADDBA response frame 400B), and may indicate denial of the ADDBA request frame 400A by setting the status code in the ADDBA response frame 400B to logic 1 (e.g., to indicate a “declined” status in the ADDBA response frame 400B).

Once the ADDBA request frame and an ADDBA response frame indicating “success” are exchanged, the BA session is established between the AP 110 and STA1. Thereafter, the AP 110 may transmit aggregated data frames to STA1, and STA1 may confirm receipt of the aggregated data frames using a single BA frame. The AP 110 and STA1 may store BA session information that includes, for example, buffer sizes, BA policies, status of the BA session, BA timeout values, and so on. For example, STA1 may store BA session information in BA session store 244 of FIG. 2, and the AP 110 may store BA session information in BA session store 344 of FIG. 3.

When STA1 is to end the BA session (e.g., because the BA session has timed out, to minimize interference between Bluetooth and Wi-Fi signals, etc.), STA1 may transmit a DELBA frame to the AP 110. The DELBA frame is an action frame defined in the IEEE 802.11 standards. For example, FIG. 40 shows an example DELBA frame 4000 including a MAC header, a category field, an action field, a number of information elements, and an FCS field. The number of octets denoted in FIG. 40 for the various fields of the DELBA frame 4000 are illustrative, and may be of other suitable values. Upon receiving the DELBA frame (e.g., DELBA frame 4000), the AP 110 may tear down the BA session, and thereafter stop aggregating data frames for transmission to STA1.

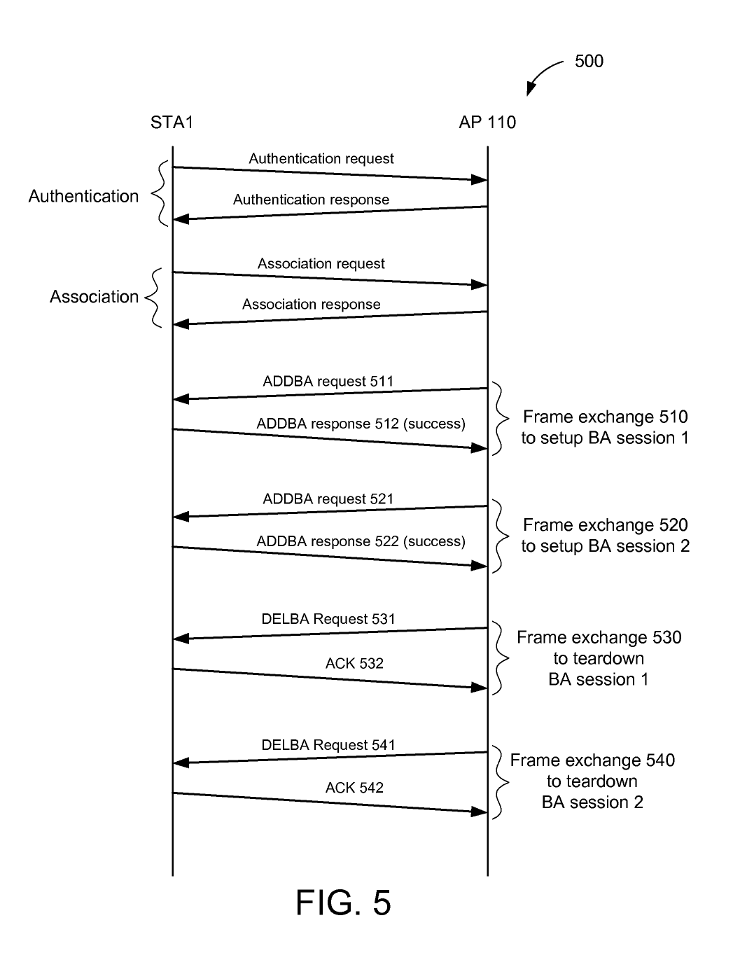

As described above, a separate exchange of an ADDBA request frame and an ADDBA response frame is typically used to establish each BA session, a separate DELBA frame is typically used to tear down each BA session, and a separate BA session is typically used for each access category or traffic priority. For example, FIG. 5 shows a sequence diagram 500 depicting example operations for establishing a connection between STA1 and AP 110, and thereafter for establishing and tearing down two BA sessions between STA1 and AP 110. As shown in FIG. 5, STA1 initiates an authentication procedure to identify itself to the AP 110, for example, by sending an authentication request frame to the AP 110. The AP 110 responds by sending an authentication response frame back to STA1. Once the authentication procedure is complete, STA1 may associate with AP 110, for example, to gain full access to the WLAN 120. Specifically, STA1 may initiate the association procedure by sending an association request frame to the AP 110. The association request frame may include information such as the STA's SSID, supported data rates, capabilities, and the like. The AP 110 responds by sending an association response frame to STA1. The association response frame includes an association identifier (AID) value assigned to STA1, and may include other information such as the AP's SS ID, supported data rates, capabilities, and so on. The assigned AID value may be used by the AP 110 to identify STA1 and to direct data transmissions to STA1, and may be used by STA1 to receive data transmissions (and for other purposes including, for example, to generate start times for transmit opportunities). For example, according to current IEEE 802.11 protocols, when AP 110 is to transmit data frames to STA1, the AP 110 embeds the AID value assigned to STA1 into the preamble of the data frames so that STA1 knows that it is the intended recipient of the transmitted data frames.

The AP 110 may initiate a first BA session for data belonging to a first access category or traffic priority, for example, by initiating a first ADDBA frame exchange 510 between AP 110 and STA1. Specifically, AP 110 may send to STA1 a first ADDBA request frame 511 containing information including, for example, buffer sizes, BA policies, status of the BA session, and so on. STA1 may accept the first ADDBA request frame 511 by sending to AP 110 a first ADDBA response frame 512 having a status code set to indicate “success.” The first BA session between STA1 and AP 110 is now active, and AP 110 may transmit aggregated data frames belonging to the first access category or traffic priority to STA1, and STA1 may confirm receipt of the aggregated data frames using a single block ACK frame. The AP 110 may initiate a second BA session for data belonging to a second access category or traffic priority by initiating a second ADDBA frame exchange 520 between AP 110 and STA1. Specifically, AP 110 may send to STA1 a second ADDBA request frame 521 containing information including, for example, buffer sizes, BA policies, status of the BA session, and so on. STA1 may accept the second ADDBA request frame 521 by sending a second ADDBA response frame 522 having a status code set to indicate “success.” The second BA session between STA1 and AP 110 is now active, and AP 110 may transmit aggregated data frames belonging to the second access category or traffic priority to STA1, and STA1 may confirm receipt of the aggregated data frames using a single block ACK frame.

After setting up the first and the second BA sessions, the two BA sessions may need to be torn down, for example, because a BA timeout limit may be reached for the two BA sessions. The AP 110 may initiate a teardown of the first BA session by initiating a first DELBA frame exchange 530 between AP 110 and STA1. Specifically, AP 110 may send a first DELBA request frame 531 to STA1. STA1 responds with an ACK frame 532, and tears down the first BA session by releasing all resources allocated for the first BA session. Similarly, the AP 110 may initiate a teardown of the second BA session by initiating a second DELBA frame exchange 540 between AP 110 and STA1. Specifically, AP 110 may send a second DELBA request frame 541 to STA1. STA1 responds with an ACK frame 542, and tears down the second BA session by releasing all resources allocated for the second BA session.

As depicted in FIG. 5, there may be substantial overhead on the shared wireless medium associated with setting up and tearing down multiple BA sessions. Therefore, it would be desirable to reduce traffic overhead associated with establishing and/or tearing down BA sessions.

In accordance with example embodiments, one or more default BA sessions may be set up during an association procedure between wireless devices (e.g., when a STA associates with an AP), for example, without any subsequent exchanges of ADDBA request and ADDBA response frames. The one or more default BA sessions may include BA sessions for a group of commonly used traffic identifiers (TIDs) or access categories (e.g., for AC_VO, AC_VI, AC_BE, and AC_BK), and may be set up during an association procedure, for example, by including BA session setup information in the association request and association response frames.

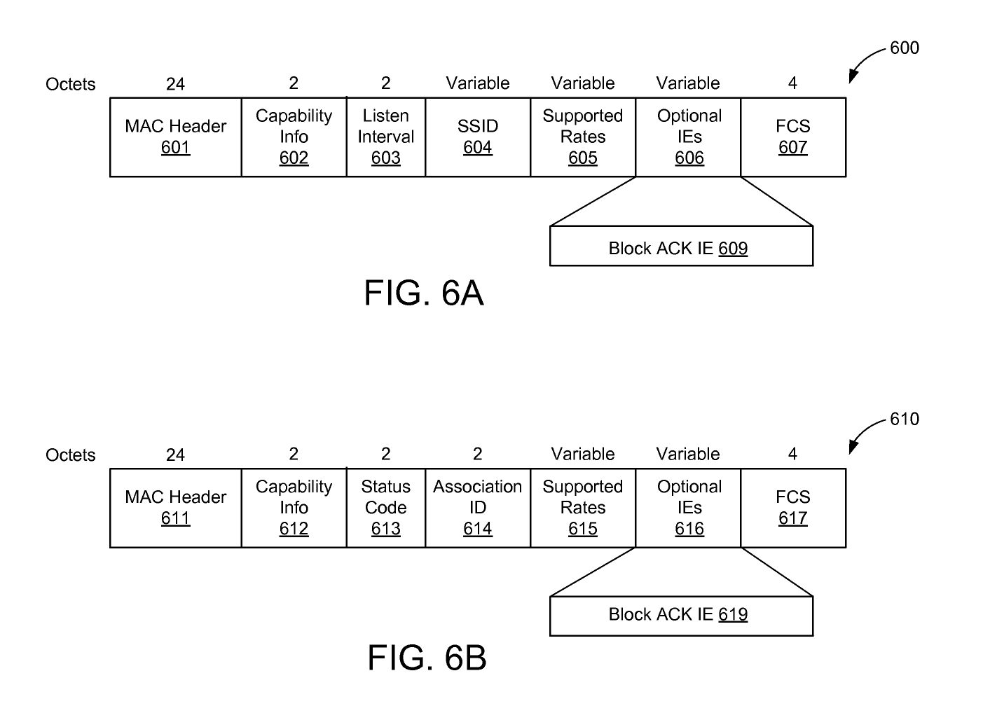

For example, FIGS. 6A and 6B depict an example association request frame 600 and an example association response frame 610, respectively, in accordance with some implementations. The association request frame 600 is shown to include a MAC header 601, a capability field 602, a listen interval field 603, an SSID field 604, a supported data rates field 605, a variable-length field 606 including a number of information elements (IEs), and an FCS field 607. The number of octets denoted in FIG. 6A for the various fields of the association request frame 600 are illustrative, and may be of other suitable values. The association response frame 610 is shown to include a MAC header 611, a capability field 612, a status code field 613, an association ID field 614, a supported data rates field 615, a variable-length field 616 including a number of information elements (IEs), and an FCS field 617. The number of octets denoted in FIG. 6B for the various fields of the association response frame 610 are illustrative, and may be of other suitable values.

At least one of the information elements provided within the association request frame 600 and/or within the association response frame 610 may be a block acknowledgement IE that, in accordance with the example embodiments, includes information to set up one or more BA sessions between wireless devices. More specifically, the association request frame 600 may include a block acknowledgement IE 609 that may be used by a first wireless device (e.g., a STA) to request a BA session while initiating an association procedure with a second wireless device (e.g., an AP), and the association response frame 610 may include a block acknowledgement IE 619 that may be used by the second wireless device to accept or decline the requested BA session while completing the association procedure with the first wireless device. Thus, for the example embodiments described herein, the block acknowledgement IEs 609 and/or 619 may contain BA session information including, for example, BA policies, BA timeout values, buffer sizes, aggregation policies, TID values, and so on. For at least one embodiment, the block acknowledgement IEs 609 and/or 619 may contain BA session information similar to that typically included in ADDBA request frames and ADDBA response frames, for example, as described above with respect to FIGS. 4A-4B. As used herein, the term “while” may mean concurrently or at substantially the same time.

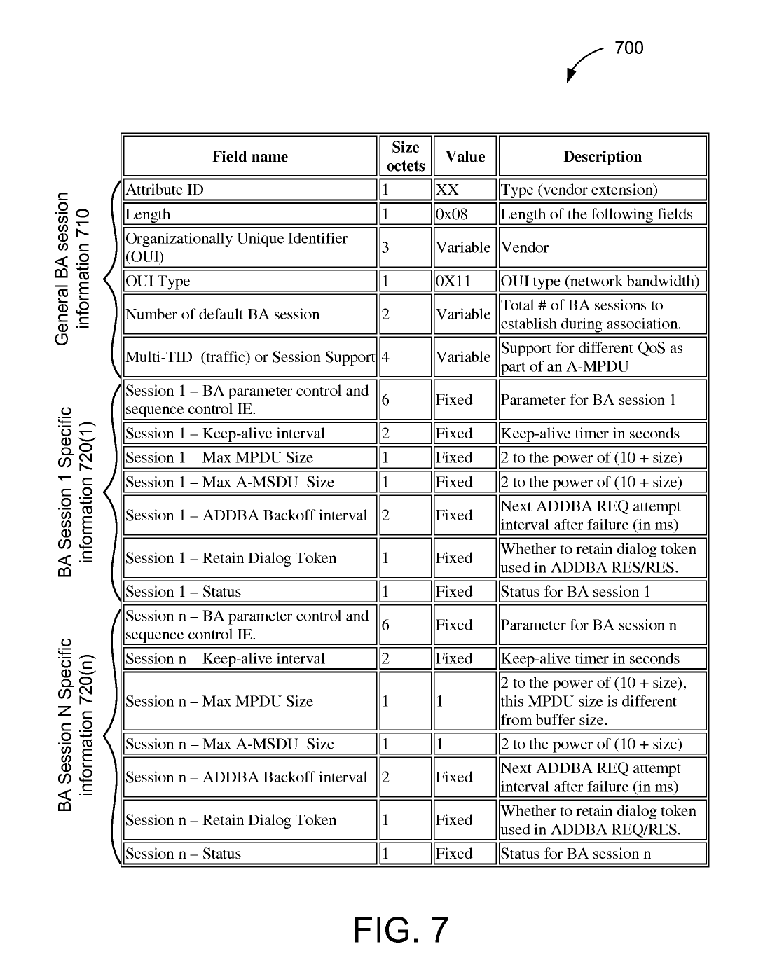

FIG. 7 shows an example BA Multi-Session Information Element (BAMS IE) 700 in accordance with example embodiments. The BAMS IE 700 may be one embodiment of the block acknowledgement IE 609 of FIG. 6A and/or the block acknowledgement IE 619 of FIG. 6B. As depicted in FIG. 7, the BAMS IE 700 may include a group of general BA session information fields 710 containing information about the BAMS IE 700 and one or more BA sessions to be established. More specifically, for the example of FIG. 7, the group of general BA session information fields 710 may include:
an attribute ID field having an example length of one octet;
a length field, having an example length of one octet, to indicate the length of the following fields of the BAMS IE 700;
an organizationally unique identifier (OUI) field, having an example length of 3 octets, to indicate an organization such as a vendor or manufacturer;
an OUI type field, having an example length of 1 octet; and
a number of default BA sessions field, having an example length of 2 octets, indicating the number of default BA sessions to be established.

The group of general BA session information fields 710 may also include a Multi-TID field indicating support for multi-TID BA sessions, as depicted in the example of FIG. 7. As mentioned above, conventional block acknowledgement protocols use a separate BA session for each access category or traffic priority. Establishing a separate BA session for different classes of data may not allow for the aggregation of MPDUs assigned to different access categories and/or having different TIDs into a single A-MPDU, for example, because only data having the same TID value may typically be exchanged for a given BA session. Thus, in accordance with example embodiments, multi-TID support may be provided for BA sessions, which in turn may allow data frames having different TID values or priority levels to be aggregated together for transmission in the same BA session. As a result, the example embodiments may alleviate the need for separate BA sessions when aggregating data assigned to different access categories and/or having different TID values.

Thus, in accordance with example embodiments, the BAMS IE 700 may include a Multi-TID field, having an example length of 4 octets, to indicate whether a receiving device supports aggregating data frames having multiple TIDs into an A-MPDU. For example, the Multi-TID field may indicate that channel acquisition for each of a number of associated A-MPDUs is to be based on the highest priority data frame or packet aggregated within each of the associated A-MPDUs. When a receiving device indicates support for Multi-TID BA sessions, a transmitting device may use a BA request (BAR) frame to request a block ACK for each TID (or may leverage the multi-TID support).

The example BAMS IE 700 depicted in FIG. 7 may also include specific information about each of the BA sessions to be established. More specifically, the example BAMS IE 700 is depicted in FIG. 7 as including a number of groups of BA session-specific information fields 720(1)-720(n) containing information describing a corresponding number of BA sessions to be established. More specifically, for the example of FIG. 7, each of the BA session-specific information fields 720(1)-720(n) may include:
a BA parameter control and sequence control IE, having an example length of 6 octets, to indicate the number of subframes, the TID for the BA session, BA policy information such as immediate vs. delayed, a BA timeout interval, and a BA starting sequence control;
a maximum MPDU size field, having an example length of one octet, to indicate the maximum permitted MPDU size for the BA session;
a maximum A-MSDU size field, having an example length of one octet, to indicate the maximum permitted A-MSDU size for the BA session;
an ADDBA backoff interval field, having an example length of 2 octets, to indicate a minimum time period between a failed ADDBA request frame and a subsequent ADDBA request frame; and
a status field, having an example length of 1 octet, to indicate the status of the BA session.

As mentioned above, a conventional BA session is typically torn down when the BA timeout interval expires; if a number of wireless devices wish to continue transmitting A-MPDUs to each other using block ACK confirmation techniques, the BA session may be re-established between the wireless devices, for example, by initiating another exchange of ADDBA request and ADDBA response frames. Thus, tearing down and then re-establishing a BA session involves at least two frame exchanges: a DELBA/ACK frame exchange to tear down the BA session, and an ADDBA request and response frame exchange to re-establish the BA session. It may be desirable to ensure that a selected number of the BA sessions are kept active and prevented from timing out (e.g., irrespective of the BA session timeout interval).

Accordingly, for some embodiments, the BAMS IE 700 may include a BA session keep-alive interval field for each of the BA sessions that may be established between wireless devices. The BA session keep-alive interval field, which may have an example length of 2 octets, may specify a value for a keep-alive timer. The keep-alive timer may be started (e.g., allowed to begin counting down from a predetermined value to 0) when the BA session is established. When the keep-alive timer expires, a null data packet may be transmitted to other wireless devices associated with the BA session, for example, to prevent the BA timeout interval from elapsing and/or to prevent the BA session from being torn down. In some embodiments, if the keep-alive interval field specifies a value of zero, then no keep-alive timer may be set.

The BAMS IE 700 may also indicate, for each BA session, whether the BA session's dialog token should be retained. The dialog token may be used to match an ADDBA request frame with a corresponding ADDBA response frame. In some embodiments, the dialog token may be retained and thereafter used in connection with a DELBA request frame to tear down the BA session.

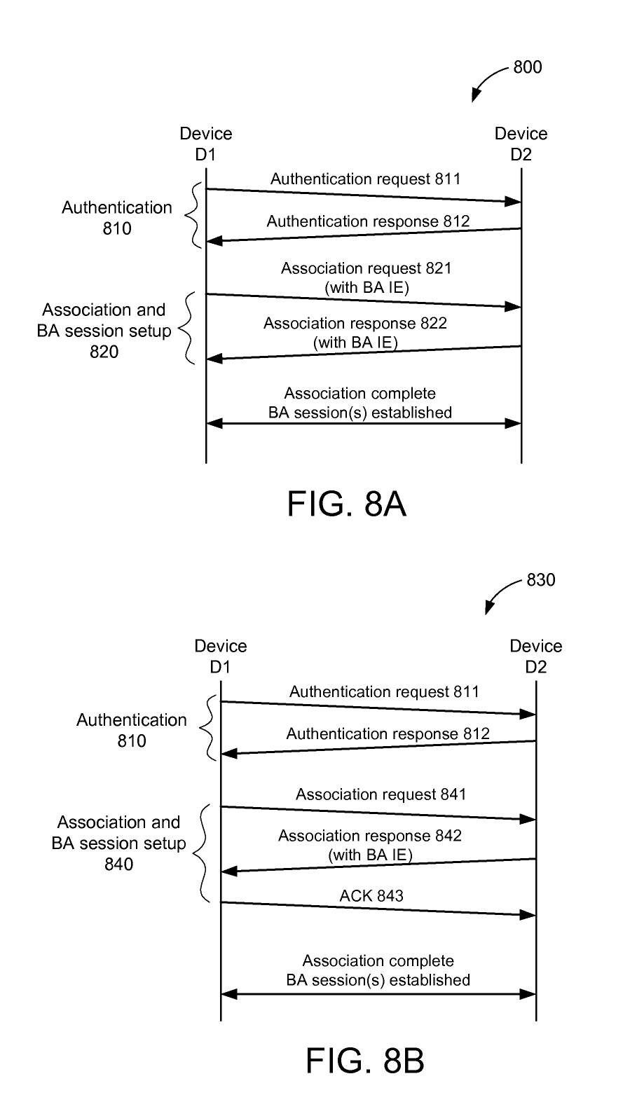

FIG. 8A is a sequence diagram 800 depicting an example setup of one or more BA sessions during an association procedure between a first wireless device D1 and a second wireless device D2. For one embodiment, device D1 may be a STA such as STA1, and device D2 may be an AP such as AP 110. For another embodiment, devices D1 and D2 may both be STAs (e.g., in an ad-hoc network, a peer-to-peer (P2P) network, or an independent basic service set (IBSS) network).

Device D1 may initiate an authentication procedure 810 to identify itself to device D2, for example, by sending an authentication request frame 811 to device D2. Device D2 may respond by sending an authentication response frame back 812 to device D1. Once the authentication procedure 810 is complete, device D1 may associate with device D2. Specifically, device D1 may initiate the association procedure 820 by sending an association request frame 821 to device D2. The association request frame 821, which may be one embodiment of the association request frame 600 of FIG. 6A, may include a block acknowledgment IE containing information for requesting and/or establishing a BA session between devices D1 and D2. For at least some implementations, the block acknowledgment IE included within the association request frame 821 may be one embodiment of the BAMS IE 700 of FIG. 7.

Device D2 responds by sending an association response frame 822 to device D1. The association response frame 822, which may be one embodiment of the association response frame 610 of FIG. 6B, may include a block acknowledgment IE containing information for accepting or declining the requested BA session between devices D1 and D2. For at least some implementations, the block acknowledgment IE included with the association request frame 821 may be one embodiment of the BAMS IE 700 of FIG. 7. More specifically, for some implementations, information provided in the block acknowledgment IE contained in the association response frame 822 may mirror information provided in the block acknowledgment IE contained in the association request frame 821, for example, to accept the BA request and confirm that the requested one or more BA sessions will be established. For other implementations, the second wireless device D2 may indicate acceptance of the BA request in the association response frame 822 without repeating the BA session information provided in the association request frame 821.

For other embodiments, device D2 may request one or more BA sessions during the association procedure 820 (e.g., when device D2 is an AP). For example, FIG. 8B is a sequence diagram 830 depicting another example setup of one or more BA sessions during an association procedure 840 between device D1 and device D2. After authentication, device D1 may initiate an association procedure 840 by sending an association request frame 841 to device D2. The association request frame 841 may be a conventional association request frame (e.g., an association request frame not containing BA session information). Device D2 responds by sending an association response frame 842 to device D1. The association response frame 842, which may be one embodiment of the association response frame 610 of FIG. 6B, may include a block acknowledgment IE containing information for requesting and/or establishing a BA session between devices D1 and D2. For at least some implementations, the block acknowledgment IE included with the association response frame 842 may be one embodiment of the BAMS IE 700 of FIG. 7, and may include information for accepting or declining the requested BA session between devices D1 and D2. Device D1 may accept or decline the requested BA session(s) by sending, to device D2, an acknowledgment (ACK) frame 843 indicating whether the requested one or more BA sessions will be established.

For still other embodiments, rather than including a block acknowledgment IE such as BAMS IE 700 in association frames, the block acknowledgment IE may instead be included within an ADDBA request frame and/or an ADDBA response frame. For example, including the BAMS IE 700 within an ADDBA request frame may allow a single exchange of ADDBA request and ADDBA response frames to setup multiple BA sessions.

The example embodiments may also allow multiple BA sessions between wireless devices to be torn down using a single DELBA frame, thereby reducing traffic overhead associated with terminating BA sessions (e.g., as compared to conventional techniques that use a separate DELBA frame to tear down each BA session). More specifically, BA session information may be provided in DELBA frames to indicate which BA sessions are to be torn down. In some embodiments, the BA session information may be provided in a traffic identifier (TID) Map IE inserted within a DELBA frame. A wireless device receiving the DELBA frame may decode the TID Map and determine, based on the logic states of the bits in the TID map, which of the BA sessions are to be torn down.

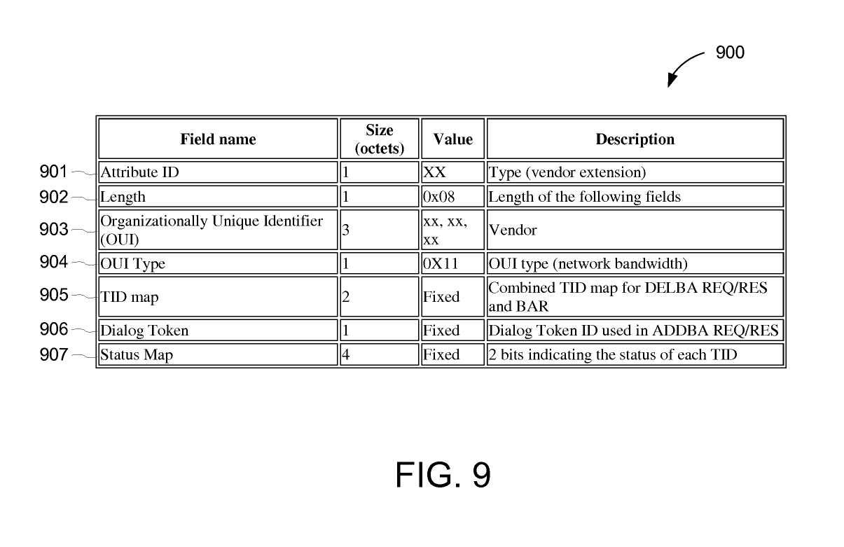

For example, FIG. 9 shows an example TID Map IE 900 in accordance with example embodiments. The TID Map IE 900 is depicted in FIG. 9 as including an Attribute ID field 901, a Length field 902, an OUI field 903, an OUI Type field 904, a TID map field 905, a dialog token field 906, and a status map field 907. The attribute ID field 901, Length field 902, OUI field 903, OUI Type field 904, and dialog token field 906 are well-known (e.g., as described above with respect to FIG. 7). The TID map field 905, which is depicted in FIG. 9 as having an example length of 2 octets, includes a TID bitmap indicating a set of TID values for which corresponding BA sessions are to be torn down. The status map field 907, which is depicted in FIG. 9 as having an example length of 4 octets, may include a status bitmap containing 2 bits for indicating the status of each TID value.

Currently, dialog token IDs are only used in ADDBA request and ADDBA response frames. However, errors may result if multiple DELBA requests are received for the same BA session (e.g., because of re-transmissions due to interference). Accordingly, in example embodiments, the dialog token field 906, depicted in FIG. 9 as having an example length of 1 octet, may be included within the TID Map IE 900 to indicate the dialog token ID. By including dialog token field 906 within the TID Map IE 900, a wireless device receiving multiple DELBA request frames for the same BA session may resolve the conflicting DELBA request frames (e.g., by recognizing the multiple DELBA request frames as duplicates).

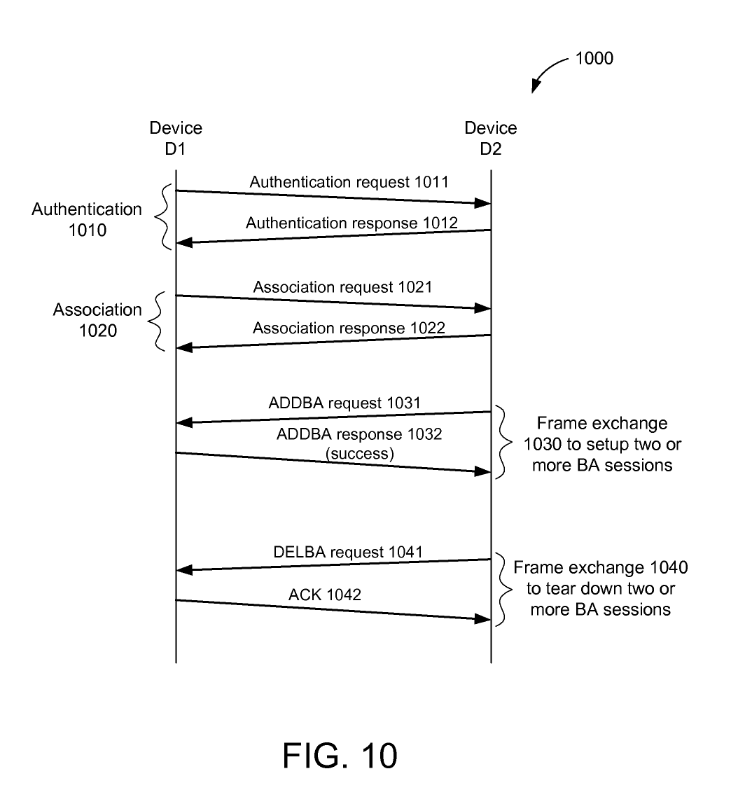

FIG. 10 is a sequence diagram 1000 depicting an example setup and teardown of two or more BA sessions, in accordance with example embodiments. The sequence diagram 1000 is described below with respect to a first wireless device D1 and a second wireless device D2. For one embodiment, device D1 may be a STA such as STA1, and device D2 may be an AP such as AP 110. For another embodiment, devices D1 and D2 may both be STAs (e.g., in an ad-hoc, P2P, or IBSS wireless network).

As shown in FIG. 10, device D1 initiates an authentication procedure 1010 to identify itself to device D2, for example, by sending an authentication request frame 1011 to device D2. Device D2 responds by sending an authentication response frame 1012 back to device D1. Once the authentication procedure 1010 is complete, device D1 may associate with device D2. Specifically, device D1 may initiate an association procedure 1020 by sending an association request frame 1021 to device D2. The association request frame 1021 may include information such as device D1's SSID, supported data rates, capabilities, and the like. Device D2 responds by sending an association response frame 1022 to device D1. The association response frame 1022 includes an association identifier (AID) for device D1, and may include other information such as device D2's SS ID, supported data rates, capabilities, and the like. The authentication procedure 1010 and association procedure 1020 depicted in FIG. 10 may be conventional (e.g., as described above with respect to FIG. 5).

After association is complete, a frame exchange 1030 may be used to set up two or more BA sessions between devices D1 and D2. Specifically, device D2 may send an ADDBA request frame 1031 to device D1. The ADDBA request frame 1031 may include information about two or more BA sessions to be set up between devices D1 and D2. In some embodiments, this information may be provided in a block acknowledgement information element such as BAMS IE 700, as described above with respect to FIG. 7. Device D1 may respond to the ADDBA request frame 1031 with an ADDBA response frame 1032 having a status code set to logic 0 to indicate acceptance of the requested BA sessions. Thus, as depicted in FIG. 10, the ADDBA response frame 1032 indicates a “success” status to confirm that the requested BA sessions will be set up. In some embodiments, the ADDBA request frame 1031 and the ADDBA response frame 1032 may have frame formats as described above with respect to FIG. 4A and FIG. 4B, respectively.

After setup of the requested BA sessions has completed, a frame exchange 1040 may be used to tear down the two or more BA sessions between devices D1 and D2. Specifically, device D2 may send a DELBA request frame 1041 that requests teardown of the two or more established BA sessions. The DELBA request frame 1041 may have a frame format as described above with respect to FIG. 40. In some embodiments, the DELBA request frame 1041 may include TID Map IE 900 (as described above with respect to FIG. 9) to indicate which BA sessions are to be torn down. Device D1 may respond to the DELBA request frame 1041 by sending an acknowledgment (ACK) frame 1042 indicating that the BA sessions indicated in the DELBA request frame 1041 will be torn down.

FIG. 11 shows an illustrative flow chart 1100 depicting an example operation for establishing one or more BA sessions during an association procedure, in accordance with example embodiments. In FIG. 11, each of the first and second wireless devices may be a STA, such as one of STA1-STA4 of FIG. 1 or STA 200 of FIG. 2, or may be an AP, such as one of AP 110 of FIG. 1 or AP 300 of FIG. 3.

As shown in the illustrative flowchart 1100 of FIG. 11, a first wireless device may receive an association request frame from a second wireless device, the association request frame including a first request to associate with the first wireless device and including a second request to establish one or more BA sessions with the first wireless device (1101). The association request frame may include a block acknowledgment IE that requests the one or more BA sessions with the first wireless device. As described above, the block acknowledgment IE may contain BA session information including, for example, BA policies, buffer sizes, one or more BA session timeout values, one or more aggregation policies, one or more TID values, and so on. In addition, for at least some embodiments, the block acknowledgment IE may also indicate a BA keep-alive interval for each of the one or more BA sessions, may specify a default number of BA sessions to be established during association of the second wireless device with the first wireless device, and/or may indicate a timeout period for at least a specified one of the BA sessions. For some implementations, the block acknowledgment IE may be a BAMS IE, for example, as described above with respect to FIG. 7.

The first wireless device may then transmit an association response frame to the second wireless device, the association response frame including at least information indicating whether the second request is accepted by the first wireless device (1102). For some implementations, the association response frame may include a block acknowledgment IE that mirrors the BA session information provided in the association request frame—which as described above may indicate acceptance of the requested BA sessions. For other implementations, the association response frame may not include a block acknowledgment IE, but rather include one or more status bits indicating whether the requested BA sessions are accepted or denied.

In some embodiments, the association request frame and the association response frame may be received and transmitted using transceivers 211 and antennas 250(1)-250(n) of STA 200 of FIG. 2, or using transceivers 311 and antennas 360(1)-360(n) of AP 300 of FIG. 3.

The first wireless device may then associate with the second wireless device based, at least in part, on the association request frame and the association response frame (1103). More specifically, the first and second wireless devices may use association information exchanged in the association request and response frames to associate with each other.

Then, the first wireless device may establish the one or more BA sessions with the second wireless device based, at least in part, on the association request frame and the association response frame (1104). For example, the first and second wireless devices may use BA session information provided in the block acknowledgment IE to negotiate parameters and/or policies of the one or more BA sessions, and thereafter set up the one or more BA sessions. In some embodiments, the one or more BA sessions may be established by executing BA session management SW module 243 of STA 200 of FIG. 2 or by executing BA session management SW module 343 of AP 300 of FIG. 3.

For at least some implementations in which the received block acknowledgment IE indicates a timeout period for at least a specified one of the BA sessions, the first wireless device may tear down the specified BA session after expiration of the timeout period without subsequent frame exchanges between the first and second wireless devices (1105). More specifically, the first and second wireless devices may automatically tear down the specified BA session, without exchanging a DELBA frame and an ACK frame, if no data frames are exchanged between the wireless devices within the timeout period. In this manner, the specified BA session may be terminated without any traffic overhead on the shared wireless medium.

Further, for some implementations, the first wireless device may send, to the second wireless device, a keep-alive signal for a selected number of the established BA sessions, the keep-alive signal instructing the second wireless device to maintain the selected number of established BA sessions in an active state after expiration of one or more corresponding BA timeout periods (1106). In this manner, the first wireless device may prolong a selected number of the BA sessions rather than tearing down the selected BA sessions (e.g., upon expiration of a BA timeout period) and then re-establishing the selected BA sessions, which may further reduce traffic on the shared wireless medium. If the block acknowledgment IE specifies a keep-alive interval for one or more BA sessions, then the first wireless device may send a null data packet once per keep-alive interval to keep the one or more BA sessions from timing out and being torn down.

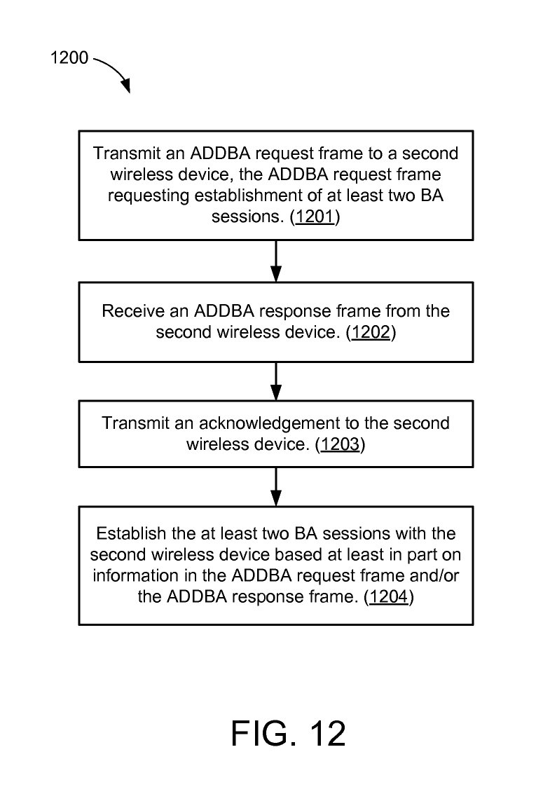

FIG. 12 shows an illustrative flow chart 1200 depicting an example operation for establishing two or more BA sessions using a single ADDBA request frame, in accordance with example embodiments. In FIG. 12, each of the first and second wireless devices may be a STA, such as one of STA1-STA4 of FIG. 1 or STA 200 of FIG. 2, or may be an AP, such as one of AP 110 of FIG. 1 or AP 300 of FIG. 3.

As shown in the illustrative flow chart 1200 of FIG. 12, a first wireless device may transmit an ADDBA request frame to a second wireless device, the ADDBA request frame requesting the setup of at least two BA sessions (1201). The first wireless device may then receive an ADDBA response frame from the second wireless device (1202). The first wireless device may send an acknowledgment (ACK) frame to the second wireless device to acknowledge receipt of the ADDBA response frame (1203). In some embodiments, the ADDBA request frame and the ADDBA response frame may be received and transmitted using transceivers 211 and antennas 250(1)-250(n) of STA 200 of FIG. 2, or using transceivers 311 and antennas 360(1)-360(n) of AP 300 of FIG. 3. The first wireless device may establish the requested two or more BA sessions with the second wireless device based at least in part on information in the ADDBA request frame and/or information in the ADDBA response frame (1204). In some embodiments, the requested two or more BA sessions may be established by executing BA session management SW module 243 of STA 200 of FIG. 2 or by executing BA session management SW module 343 of AP 300 of FIG. 3.

In some embodiments, the ADDBA request frame and/or the ADDBA response frame may include a block acknowledgment IE that contains information indicating which BA sessions are to be set up and/or indicating various parameters (e.g., BA policies, buffer sizes, one or more BA session timeout values, one or more aggregation policies, one or more TID values, and so on) of the BA sessions to be established). The block acknowledgment IE may also specify a keep-alive interval for a selected number of the BA sessions. If the block acknowledgment IE specifies a keep-alive interval for one or more selected BA sessions, then the first wireless device may send a null data packet once per keep-alive interval to keep the one or more selected BA sessions from timing out and being torn down. For at least one implementation, the block acknowledgment IE included within the ADDBA request frame and/or the block acknowledgment IE included within the ADDBA response frame may be one embodiment of the BAMS IE 700 of FIG. 7.

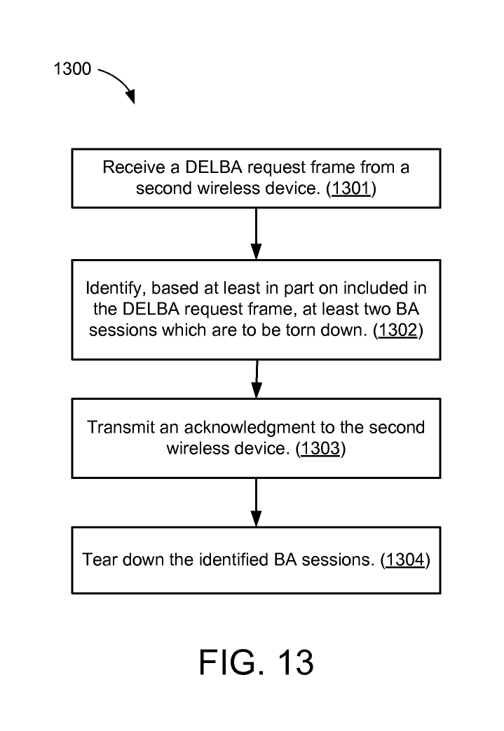

FIG. 13 shows an illustrative flow chart 1300 depicting an example operation for tearing down two or more BA sessions, in accordance with the example embodiments. In FIG. 13, each of the first and second wireless devices may be a STA, such as one of STA1-STA4 of FIG. 1 or STA 200 of FIG. 2, or may be an AP, such as one of AP 110 of FIG. 1 or AP 300 of FIG. 3. In some embodiments, the first and the second wireless device may respectively comprise a STA and an AP, where the STA is associated with the AP, and where at least two BA sessions have been established between the STA and the AP.

As shown in the flowchart 1300 of FIG. 13, a first wireless device may receive a DELBA request frame from a second wireless device (1301). The DELBA request frame may be received using transceivers 211 and antennas 250(1)-250(n) of STA 200 of FIG. 2, or using transceivers 311 and antennas 360(1)-360(n) of AP 300 of FIG. 3. The first wireless device may then identify, based at least in part on information provided in the DELBA request frame, at least two BA sessions which are to be torn down (1302). In some embodiments, the first wireless device may identify the BA sessions to be torn down by executing BA session management SW module 243 of STA 200 of FIG. 2 or by executing BA session management SW module 343 of AP 300 of FIG. 3.

In some embodiments, the DELBA request frame may include a block acknowledgment IE that contains information identifying which of the BA sessions are to be torn down. The block acknowledgment IE provided within the DELBA request frame may include a TID Map that identifies the BA sessions to be torn down, and/or may include a dialog token that, as described above, may be used to resolve conflicts when multiple DELBA request frames are received for the same BA session.

Next, the first wireless device may transmit an acknowledgment (ACK) frame to the second wireless device to acknowledge receipt of the DELBA request frame (1303). The ACK frame may be transmitted using transceivers 211 and antennas 250(1)-250(n) of STA 200 of FIG. 2, or using transceivers 311 and antennas 360(1)-360(n) of AP 300 of FIG. 3. The first wireless device may then tear down the BA sessions identified by the DELBA request frame (1304).

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media.

In the foregoing specification, the example embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method for establishing a number of block acknowledgment (BA) sessions between a first wireless device and a second wireless device, the method performed by the first wireless device and comprising:
receiving an association request frame from the second wireless device, the association request frame including a first request to associate with the first wireless device and including a second request to establish one or more BA sessions with the first wireless device;
transmitting an association response frame to the second wireless device, the association response frame including information indicating whether the second request is accepted by the first wireless device;
associating the second wireless device with the first wireless device based, at least in part, on the association request frame and the association response frame; and
establishing the one or more BA sessions between the first wireless device and the second wireless device based, at least in part, on the association request frame and the association response frame.

2. The method of claim 1, wherein the one or more BA sessions are established during association of the second wireless device with the first wireless device.

3. The method of claim 1, wherein the association request frame includes a block acknowledgment information element (IE) containing the second request to establish the one or more BA sessions.

4. The method of claim 3, wherein the block acknowledgment IE further comprises at least one member of the group consisting of a BA policy, one or more BA buffer sizes, one or more BA session timeout values, one or more aggregation policies, and one or more traffic identifier (TID) values.

5. The method of claim 3, wherein the block acknowledgment IE indicates a BA keep-alive interval for each of the one or more BA sessions.

6. The method of claim 3, wherein the block acknowledgment IE indicates whether the second wireless device supports aggregation of data having different traffic identifier (TID) values in a single BA session.

7. The method of claim 3, wherein the block acknowledgment IE specifies a default number of BA sessions to be established during association of the second wireless device with the first wireless device.

8. The method of claim 3, wherein the first wireless device is associated with a number of different traffic identifier (TID) values, and the block acknowledgment IE includes a separate BA parameter control set for each of the number of different TID values.

9. The method of claim 3, wherein the block acknowledgment IE indicates a timeout period for a number of specified BA sessions, the method further comprising:
tearing down the number of specified BA sessions after expiration of the timeout period without frame exchanges between the first and second wireless devices.

10. The method of claim 1, further comprising:
sending, to the second wireless device, a keep-alive signal for a selected number of the established BA sessions, the keep-alive signal instructing the second wireless device to maintain the selected number of established BA session in an active state after expiration of a number of corresponding BA timeout periods.

11. A first wireless device, comprising:
a number of transceivers to exchange data with at least a second wireless device;
one or more processors; and
a memory storing instructions that, when executed by the one or more processors, cause the first wireless device to:
receive an association request frame from the second wireless device, the association request frame including a first request to associate with the first wireless device and including a second request to establish one or more block acknowledgment (BA) sessions with the first wireless device;
transmit an association response frame to the second wireless device, the association response frame including information indicating whether the second request is accepted by the first wireless device;
associate the second wireless device with the first wireless device based, at least in part, on the association request frame and the association response frame; and
establish the one or more BA sessions between the first wireless device and the second wireless device based, at least in part, on the association request frame and the association response frame.

12. The first wireless device of claim 11, wherein the association request frame includes a block acknowledgment information element (IE) containing the second request to establish the one or more BA sessions.

13. The first wireless device of claim 12, wherein the block acknowledgment IE further comprises at least one member of the group consisting of a BA policy, one or more BA buffer sizes, one or more BA session timeout values, one or more aggregation policies, and one or more traffic identifier (TID) values.

14. The first wireless device of claim 12, wherein the block acknowledgment IE indicates a BA keep-alive interval for each of the one or more BA sessions.

15. The first wireless device of claim 12, wherein the block acknowledgment IE indicates whether the second wireless device supports aggregation of data having different traffic identifier (TID) values in a single BA session.

16. The first wireless device of claim 12, wherein the block acknowledgment IE specifies a default number of BA sessions to be established during association of the second wireless device with the first wireless device.

17. The first wireless device of claim 12, wherein the first wireless device is associated with a number of different traffic identifier (TID) values, and the block acknowledgment IE includes a separate BA parameter control set for each of the number of different TID values.

18. The first wireless device of claim 12, wherein the block acknowledgment IE indicates a timeout period for a number of specified BA sessions, and execution of the instructions by the one or more processors causes the first wireless device to:
tear down the number of specified BA sessions after expiration of the timeout period without frame exchanges between the first and second wireless devices.

19. The first wireless device of claim 11, wherein execution of the instructions by the one or more processors causes the first wireless device to:
send, to the second wireless device, a keep-alive signal for a selected number of the established BA sessions, the keep-alive signal instructing the second wireless device to maintain the selected number of established BA session in an active state after expiration of a number of corresponding BA timeout periods.

20. A non-transitory computer-readable medium storing instructions that, when executed by one or more processors of a first wireless device, causes the first wireless device to:
receive an association request frame from a second wireless device, the association request frame including a first request to associate with the first wireless device and including a second request to establish one or more block acknowledgment (BA) sessions with the first wireless device;
transmit an association response frame to the second wireless device, the association response frame including information indicating whether the second request is accepted by the first wireless device;
associate the second wireless device with the first wireless device based, at least in part, on the association request frame and the association response frame; and
establish the one or more BA sessions between the first wireless device and the second wireless device based, at least in part, on the association request frame and the association response frame.

21. The non-transitory computer-readable medium of claim 20, wherein the association request frame includes a block acknowledgment information element (IE) containing the second request to establish the one or more BA sessions.

22. The non-transitory computer-readable medium of claim 21, wherein the block acknowledgment IE further comprises at least one member of the group consisting of a BA policy, one or more BA buffer sizes, one or more BA session timeout values, one or more aggregation policies, and one or more traffic identifier (TID) values.

23. The non-transitory computer-readable medium of claim 21, wherein the block acknowledgment IE indicates whether the second wireless device supports aggregation of data having different traffic identifier (TID) values in a single BA session.

24. The non-transitory computer-readable medium of claim 21, wherein the block acknowledgment IE indicates a timeout period for a number of specified BA sessions, and execution of the instructions by the one or more processors causes the first wireless device to:
tear down the number of specified BA sessions after expiration of the timeout period without frame exchanges between the first and second wireless devices.

25. The non-transitory computer-readable medium of claim 20, wherein execution of the instructions by the one or more processors causes the first wireless device to:
send, to the second wireless device, a keep-alive signal for a selected number of the established BA sessions, the keep-alive signal instructing the second wireless device to maintain the selected number of established BA session in an active state after expiration of a number of corresponding BA timeout periods.

26. A first wireless device, comprising:
means for receiving an association request frame from a second wireless device, the association request frame including a first request to associate with the first wireless device and including a second request to establish one or more block acknowledgment (BA) sessions with the first wireless device;
means for transmitting an association response frame to the second wireless device, the association response frame including information indicating whether the second request is accepted by the first wireless device;
means for associating the second wireless device with the first wireless device based, at least in part, on the association request frame and the association response frame; and
means for establishing the one or more BA sessions between the first wireless device and the second wireless device based, at least in part, on the association request frame and the association response frame.

27. The first wireless device of claim 26, wherein the association request frame includes a block acknowledgment information element (IE) containing the second request to establish the one or more BA sessions.

28. The first wireless device of claim 27, wherein the block acknowledgment IE further comprises at least one member of the group consisting of a BA policy, one or more BA buffer sizes, one or more BA session timeout values, one or more aggregation policies, and one or more traffic identifier (TID) values.

29. The first wireless device of claim 27, wherein the block acknowledgment IE indicates a timeout period for a number of specified BA sessions, the first wireless device further comprising:
means for tearing down the number of specified BA sessions after expiration of the timeout period without frame exchanges between the first and second wireless devices.

30. The first wireless device of claim 26, further comprising:
means for sending, to the second wireless device, a keep-alive signal for a selected number of the established BA sessions, the keep-alive signal instructing the second wireless device to maintain the selected number of established BA session in an active state after expiration of a number of corresponding BA timeout periods.
